(19) United States
(12) Patent Application Publication
(10) Pub. No.: US 2009/0012811 A1
(43) Pub. Date: Jan. 8, 2009

(54) METHOD TO COLLECT AND OFFER CERTIFIED INFORMATION ON OPTIMIZED CLINICAL PROCESSES TO HEALTH INSTITUTIONS USING SEARCH ENGINES

(76) Inventors: Sultan Haider, Erlangen (DE); Klaus Abraham-Fuchs, Erlangen (DE)

Correspondence Address: BRINKS HOFER GILSON & LIONE, P.O. BOX 10395, CHICAGO, IL, 60610, US

(21) Appl. No.: 11/772,402

(22) Filed: Jul. 2, 2007

(51) Int. Cl. G06Q 50/00

(52) U.S. Cl. 705/2

(57) ABSTRACT

A system and method develop and distribute model descriptions for benchmarked and optimized clinical workflows. Benchmarked clinical workflows may be developed and a corresponding database built. The database may be remotely searchable via a search engine over a communications network, such as the Internet. Remote health institution customers may remotely access and download virtual representations of benchmarked clinical workflows. The benchmarked clinical workflows may be modified or optimized to account for the characteristics and/or restrictions of a remote health institution. The savings associated with the benchmarked or optimized clinical workflows may be automatically derived and quantified with respect to manpower, money, and time. In one aspect, the benchmarked clinical workflows may have associated interactive software applications or include modifications to existing software applications that may operate on a customer's local workstation. The software applications may facilitate medical procedures and/or the operation of medical equipment, including medical imaging devices.

### BACKGROUND

The present embodiments relate generally to the improvement of workflows. More particularly, the present embodiments relate to the development and the remote distribution of benchmarked workflows.

Conventional clinical workflow information technology (IT) solutions may require a formalized description of clinical workflows for implementation. With typical tools, clinical workflows may be described in a machine-readable and formalized way. However, many health institutions have yet to start or have only begun the process of optimizing and formalizing their clinical workflows. Hence, for most health care institutions, clinical workflow processes may remain far from being optimized and/or standardized.

Additionally, individual health institutions may have limited or restricted resources, including personnel and equipment. As a result, a general standardized workflow may not be optimal for a particular institution. Also, new advancements in medicines and medical devices continue to be made which may require entirely new procedures to be developed. Moreover, health institutions may be remotely located among different geographical regions, hindering the sharing of information between institutions.

### BRIEF SUMMARY

A system and method develop and distribute model descriptions for benchmarked or optimized clinical workflows. A database of benchmarked clinical workflows may be built. The database may be remotely searchable via a search engine over a communications network, such as the Internet. As a result, remote health institution customers may remotely access and download virtual representations of benchmarked clinical workflows. The benchmarked clinical workflows may be modified or further optimized to account for the characteristics and/or restrictions of a remote health institution. The savings associated with a benchmarked or optimized clinical workflow, as compared to a current workflow, may be automatically or manually derived and quantified with respect to manpower, money, and time, and presented to the customer. In one aspect, a benchmarked clinical workflow may have an associated interactive software application or a modification to an existing software application that runs on a local workstation at the customer's location. The software application may facilitate the completion of a medical procedure and/or the operation of medical equipment, including medical imaging devices.

In one embodiment, a method distributes benchmarked clinical workflows. The method includes offering remote access to a certified database containing machine readable representations of a plurality of benchmarked clinical workflows, the certified database being remotely searchable via a communications network.

In another embodiment, a method distributes benchmarked clinical workflows. The method includes building a certified database containing virtual representations of benchmarked clinical workflows and distributing the virtual representations of the benchmarked clinical workflows over a communications network via a search engine operable to search the certified database for a desired benchmarked clinical workflow.

In another embodiment, a data processing system distributes benchmarked clinical workflows. The data processing system includes a memory unit located at a central location operable to store a certified database containing machine readable representations of benchmarked clinical workflows. The data processing system also includes a processing unit operable to (1) permit remote searching of the certified database for a desired clinical workflow via a search engine over a communications network, and (2) offer remote access via the communications network to a machine readable representation of a benchmarked clinical workflow remotely selected from the certified database.

In yet another embodiment, a computer-readable medium provides instructions executable on a computer. The instructions direct receiving customer specific data related to a benchmarked clinical workflow from a remote customer location, modifying the benchmarked clinical workflow based upon the customer specific data, and transferring a virtual representation of the modified benchmarked clinical workflow to the remote customer location.

Advantages will become more apparent to those skilled in the art from the following description of the preferred embodiments which have been shown and described by way of illustration. As will be realized, the system and method are capable of other and different embodiments, and their details are capable of modification in various respects. Accordingly, the drawings and description are to be regarded as illustrative in nature and not as restrictive.

### BRIEF DESCRIPTION OF THE DRAWINGS

FIG. 1 illustrates an exemplary technique of developing and distributing benchmarked clinical workflows;

FIG. 2 illustrates another exemplary technique of developing and distributing benchmarked clinical workflows; and

FIG. 3 illustrates an exemplary data processor configured or adapted to provide the functionality for developing, distributing, and/or accessing benchmarked clinical workflows.

### DETAILED DESCRIPTION

The embodiments described herein include methods, processes, apparatuses, instructions, systems, or business concepts for developing and distributing benchmarked and/or optimized clinical workflow descriptions to interested users. A central health organization having extensive medical expertise and resources may develop a “certified” database containing information associated with a number of benchmarked or otherwise optimized clinical workflows. After being built, the certified database may be remotely accessed via the Internet or another wired or wireless communications network. The database may be remotely searchable for desired workflows via a search engine from remote health institution customer locations. The remote customers may remotely access the certified database and download virtual representations of desired clinical workflows remotely selected from the certified database.

The benchmarked clinical workflows also may be modified (or further optimized) to account for the characteristics and/or restrictions of a remote health institution. The savings associated with the implementation of a benchmarked or modified benchmarked clinical workflow may be quantified with respect to manpower, money, time, and/or other resources. The automatically or manually calculated savings may be presented to the customer, such as via a hard copy of a report or a display screen. As a result of the above, many health institutions with only limited resources that have yet to optimize or formalize various clinical workflows may take advantage of the knowledge of a central health organization.

In general, forerunners in the creation of benchmarked clinical workflow processes may create revenues through the marketing of certified benchmarked clinical workflow descriptions. At the same time, healthcare institutions which are still in the process of optimizing their clinical workflows may profit from the experience of these forerunners and gain workflow optimizations in a cost and time efficient manner. The present embodiments also may contribute to standardizing clinical workflows and making differences more transparent to customers and patients.

The method of developing and distributing clinical workflows may include one or more of the following steps: (1) manually describing new or existing benchmarked processes; (2) extracting model descriptions for optimal clinical workflow processes, such as benchmarked processes, golden standards, or other workflows, for existing forms of information; (3) building a certified database from the process descriptions developed in (1) and/or (2); (4) offering the certified database as a web service, either directly to the customers or through a search engine; (5) compensating the clinical partners that have developed the processes with direct payments, by sharing revenue generated from the processes, or by affording the partners the opportunity of promotion through a website or other portal; (6) “certifying” the information offered, such as by mapping current clinical processes to established clinical guidelines, relying upon the expertise of experts, or other methods; (7) generating outcome quantifications on savings and/or quality improvements; (8) modifying the “best practice” process to adapt to resource restrictions of particular customers; and/or (9) informing customers about the potential consequences that the resource restrictions may have upon benchmark parameters associated with the process. The method may include additional, fewer, or alternative actions.

In one aspect, the clinical workflows may be accomplished, at least in part, using one or more interactive software applications used by customer personnel at various customer locations. For example, the clinical workflows and associated interactive software applications may be directed toward medical applications. The clinical workflows and software applications may assist medical personnel located at hospitals and other medical facilities to diagnose and treat patients. The workflows and software applications may support medical imaging techniques and devices. The workflows and software applications may be directed toward other types of applications as well, both medical and non-medical.

### I. Exemplary Workflow Development and Distribution Methods

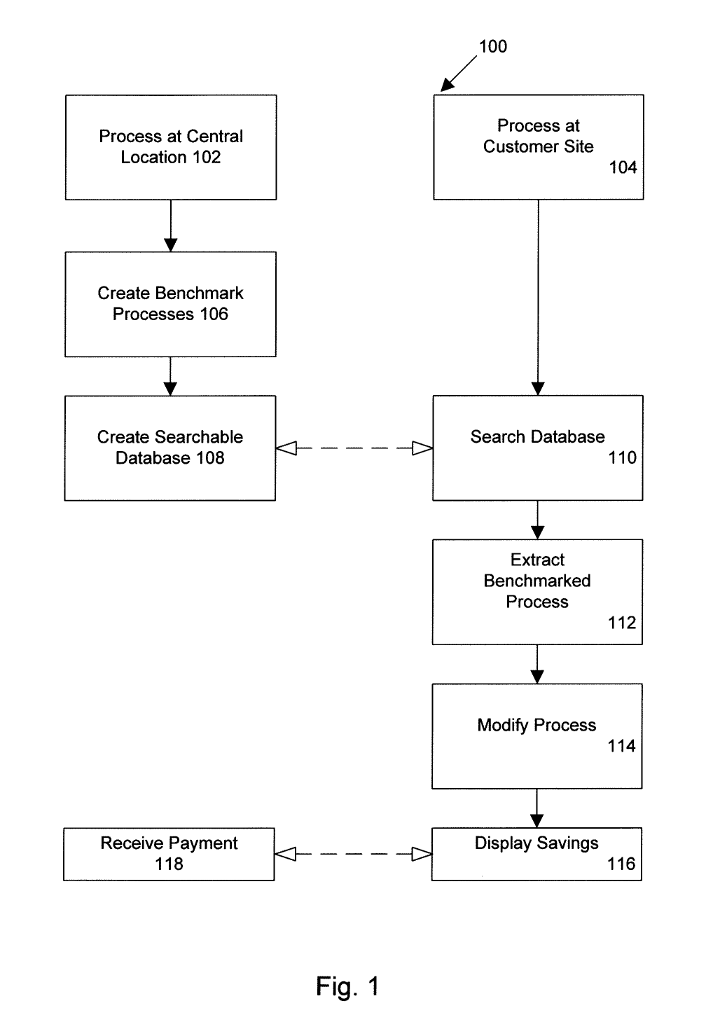

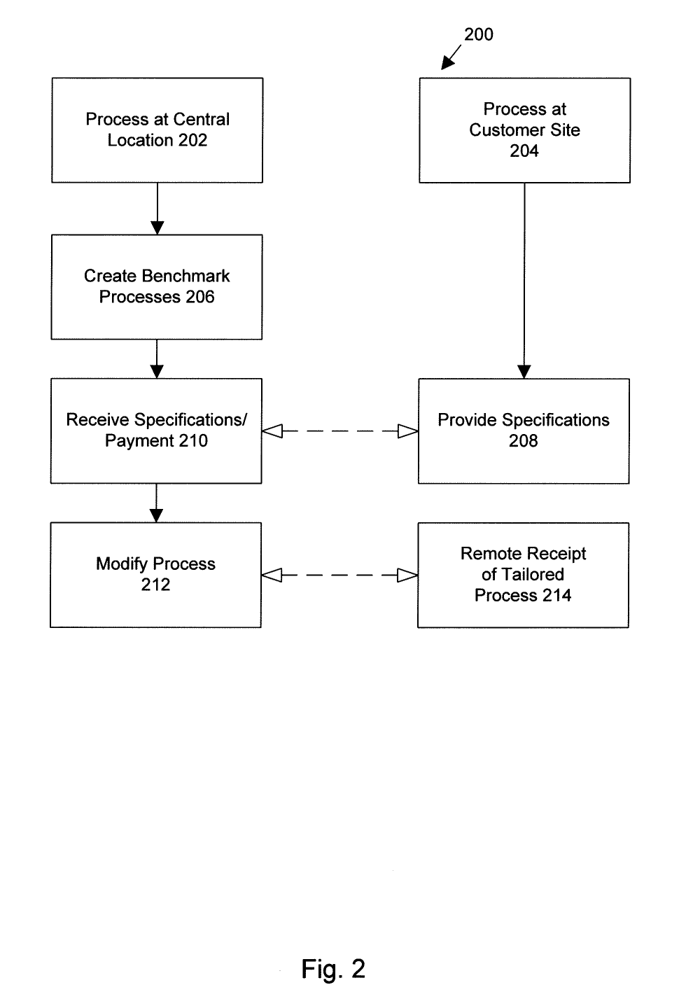

FIG. 1 illustrates an exemplary method of developing and distributing benchmarked or other optimized clinical workflows 100. The left hand side of FIG. 1 illustrates steps preferably performed at a central location 102 and the right hand side illustrates steps preferably performed at a customer location 104, such as a remote healthcare institution. The actions associated with the central location may include developing benchmarked workflows 106, building a searchable certified database of the benchmarked workflows 108, and/or receiving a form of payment 118. The actions performed at the remote customer location may include searching the certified database 110, extracting a desired benchmarked process 112, modifying the process 114, and/or displaying savings associated with either the benchmarked or modified process 116. Additional, fewer, or alternate steps may be performed at either the central location or the customer site, including, but not limited to, those discussed herein or associated with FIG. 2.

The method 100 may include developing benchmarked clinical workflows 106. In general, benchmarking is a process or a tool that may improve processes or workflows. Benchmarking may involve identifying, understanding, and adapting outstanding practices from organizations located around the globe to improve performance. Benchmarking may look to find the so-called “best practices” having the optimal performances, as well as measure actual workflows currently being used against the best practices.

The process of benchmarking may involve not only determining who performs the workflow the best, but also which processes are adaptable to other healthcare institutions. Benchmarking may further involve evaluating various aspects of a particular institution's current processes in relation to a best practice. This may facilitate the determination of how to adopt such best practice, usually with the aim of increasing some aspect of performance. Benchmarking may be a one-time event or an on-going process seeking to continually improve performance.

The advantages of benchmarking include overcoming the common attitude that the current workflow is appropriate because “that's the way we've always done it.” Benchmarking fosters considering new methods and ideas to improve efficiency and overall performance. Benchmarking also may demonstrate that a different approach is better because others have successfully used that or a similar approach. With the embodiments discussed herein, to improve effectiveness, benchmarking may be accomplished by a number of institutions working in concert, such as a large organization with vast experience and resources working with a smaller organization with limited resources. The workflows of a smaller organization may be tailored or modified based upon its individual characteristics, such as its equipment and level of experience. Additionally, benchmarking may involve surveying healthcare institutions to identify industry wide problems, as well as the current best practices for given types of workflows.

In one embodiment, the benchmarked clinical workflows may be developed by (1) determining the appropriate steps for a benchmarked process and then manually describing and documenting the benchmark processes, and/or (2) extracting model descriptions for optimal clinical workflow processes, based upon benchmark processes, golden standards, or other workflows, from existing forms of information, such as manuals, books, and computers. Alternative manners of benchmarking clinical workflows may be employed. The clinical workflows may be “certified” by physicians with sufficient experience and/or by comparison with medical standards/guidelines. Each benchmarked workflow developed may be converted to a machine readable representation, a computer file, digital data, or other computer related or virtual representation/description.

The workflows benchmarked may be general. Alternatively, more specific benchmarked workflows may account for individual patient characteristics, such as sex, age, diseases, past and current illnesses, weight, height, allergies, symptoms, religion, race, ethnicity, medical history, and other characteristics of the patient. The benchmarked workflows may account for the geographical region or location of the customer, including temperature. A hospital in a certain country may treat mostly patients of a specific race, ethnicity, size, religion, cultural preferences, or other characteristic. Accordingly, certain worksteps of a workflow may be preferably altered based upon the climate or likely patient characteristics associated with the customer's location.

In one aspect, the benchmarked clinical workflows may relate to the integration of a clinical workflow across care settings. The workflows may be engineered to synchronize a number of processes and employ a user interface tailored to the needs of a customer. In one embodiment, the workflows may be implemented via an IT solution, such as Siemens' Soarian Clinical Access™ that provides access to clinical repository data from Syngo™-enabled imaging workstations, and brings diagnostics and IT to a single workstation. Syngo™ is a medical imaging operating system and user interface that works with various imaging technology, while Soarian™ employs a browser enabled user interface modeled on Syngo™ and offers ease of navigation by giving all medical images, clinical, and financial data a common look and feel, and organizing everything into one logical, patient-centric view.

The workflows to be benchmarked may be selected based upon clinical trends determined by analyzing clinical trend data. Certain geographic locations may be experiencing or expected to experience an increase in one or more specific illnesses. Larger aging populations may be expected to yield increases in certain illnesses and accompanying increases in medical procedures required to treat those illnesses. The clinical trend data may be analyzed similar to the manner described in U.S. patent application Ser. No. 11/300,574, published as US 2007/0136355 A1, incorporated herein by reference in its entirety, which describes a method and system to detect and analyze clinical trends and associated business logic.

The method 100 may include creating a certified database associated with the benchmarked workflows 108. The certified database may be created by a software expert. The software expert may create virtual representations of benchmarked workflows and place the virtual representations in a new or an existing database. The certified database may provide an efficient manner of offering the certified benchmarked workflows to customers and remotely distributing the benchmarked workflows. In other words, the certified workflows may provide a mechanism for the efficient transfer of knowledge from a health organization with extensive expertise and experience to remote medical facilities with limited resources and less experienced personnel.

New technology also leads to new implementations and/or problems. The benchmarked workflows discussed herein may present solutions to those problems. For instance, medical technology and equipment become more complicated on a routine basis. Health facilities with fewer resources may only receive new and more advanced technology after that technology has been available for a period of time at other facilities with more resources and funding. The certified benchmarked workflows may provide an efficient manner of transferring the knowledge gained by the facilities that have already experienced the “growing pains” associated with new medical advancements. As a result of the present embodiments, an optimal manner of operating new equipment may be easily relayed to facilities subsequently acquiring that new equipment without those facilities having to inefficiently “re-invent the wheel.”

The method 100 may include “certifying” the information by mapping the clinical processes to established clinical guidelines and/or having the processes verified by experienced physicians. A certified benchmarked or optimized workflow may be in a machine readable virtual form that includes a reproducible written description, graphical depiction, table, text, article, flowchart, video, audio tape, and/or other virtual or machine readable representation of the best way of performing that workflow. For example, a graphic, table, or other visual representation may be presentable to the user that displays the process steps (such as a graphic depiction of one or more of the worksteps, along with associated textual and/or audio information related to the worksteps) of the implemented process and the corresponding clinical guideline.

After the database is certified, the method may include remotely offering the certified workflows contained within the database in a machine readable format to customers over a communications network, such as the Internet. Additionally, the certified database may be searchable. Accordingly, the method 100 may include remotely searching the certified database 110 for desired clinical workflows from a remote customer location over the communications network.

The user may search the certified database by entering search terms according to known search and/or rule based techniques. By remotely entering search terms, the user may be returned a specific workflow or a scrollable list of workflows. If a list is returned and displayed on a screen, the user may then select a desired workflow from the list, such as by moving a cursor via a mouse or other known input devices.

The user may search for customized benchmark workflows based upon illness, geographical region, patient characteristics (age, height, weight, sex, medical history, family history, religion, etc.), available medical equipment, symptoms, originator of the workflow (e.g., physician and/or institution) and other factors. Different benchmark workflows for a same situation may be provided. As a result of the search, how to best treat the relatively unusual case, especially from the point of view of a smaller institution with fewer patients, may be efficiently passed from the central location or large medical facility that has already solved the problem to that smaller institution. For example, how to best treat a male patient of “X” years of age having “Y” medical history and exhibiting “Z” symptoms may be one of the rarely experienced in real life benchmarked workflows that may be remotely accessed.

In one embodiment, the certified database may be offered as a web service, either directly to the customers or through search engines, such as Google or Yahoo. The method may employ a search engine as disclosed by U.S. Pat. Nos. 6,421,675, 5,987,446, 6,169,992, or 5,873,080, which are all incorporated herein by reference in their entireties. Other search engines may be used.

After the user remotely searches the certified database and locates a desired workflow, the user may remotely extract the selected benchmarked workflow 112 from the certified database. The user may download a file, data, or other machine readable or virtual representation of the benchmarked workflow. The virtual representation downloaded may permit a graphical, textual, audio, video, or combination thereof reproduction of the benchmarked workflow to be generated at the remote customer site.

The certified database alternatively may be transferred to customer locations from the central location via portable storage medium, such as digital versatile disc, compact disc, or other electronic storage units. Once installed on a customer machine, the certified database may be searched locally at the customer location, such as via a search engine. Alternate methods of transferring and/or distributing the contents of the certified database to the customer may be used.

The method 100 may include modifying the benchmarked workflow selected by the user 114. If an interested new user of a process has resource restrictions, the method may include (1) modifying the best practice process to adapt to these resource restrictions and (2) informing the user about the consequences of the resource restrictions on the process benchmark parameters. In one aspect, the benchmarked workflow may be modified to account for customer restrictions, preferences, and/or case specifics. For instance, a benchmarked workflow, benchmarked in the general sense, may subsequently be modified to create an optimized benchmarked workflow based upon customer specifications.

The method 100 may include displaying savings associated with either benchmarked or modified benchmarked workflows 116. The method 100 may involve deriving outcome quantifications on savings and/or quality improvements, such as in the case where a clinical IT tool, such as Sorian™, is used for process implementation. The quantification of savings may be achieved by deriving measures for process duration, manpower consumption, and direct cost involved in the project. Such measures can be given for a complete process, or preferably be broken down on sub-process levels, so that it may be made apparent to the end-user which parts of the process consume an over-proportional or excessive amount of time, cost, and/or manpower and thus are critical to change for process optimization.

The measures for cost, duration, and manpower may either be derived from a process model, or preferably, through measuring correlated parameters in the everyday clinical use of an installed clinical workflow engine. Each parameter may be associated with a measurement/quantification of cost, duration, manhours, or other resources expended during the performance of a workflow. The parameters may be automatically or manually monitored and associated data collected. For instance, a software routine may be written by a software expert and may be added to the clinical workflow engine on the customer's machine(s). After the parameters are measured and/or gathered they may be correlated, linked, or otherwise cross referenced with one another.

Similarly, process quality measures may be derived from measuring the number of warnings, alarms, error messages, etc. during the everyday clinical use of an installed clinical workflow engine. Alternatively, approximate quality measures may be manually estimated or derived from a processor if data associated with the workflows is automatically collected in an electronic format, such as via electronic clip boards and/or digital pens. These quality measures may be automatically or manually correlated with processes or sub-processes within a workflow, benchmarked workflow, and/or optimized workflow.

Benchmark performance parameters that quantify the quality of a workflow also may be derived, either automatically via a processor or manually. A software expert may create a software application that allows the performance parameters to be graphically and/or textually represented to the customer, such as via a display. The performance parameters of a benchmarked or modified benchmarked workflow may be compared to parameters of a currently used practice to calculate savings or illustrate results achieved, such as via a user interface or other display. The performance parameters may relate to manhours, cost, duration, customer satisfaction, and other savings or measurements.

As another option for disclosing the quality of a process, process steps which serve as or maintain quality control can be marked or visually identified. A software expert may link the process steps within a workflow that are related to quality control, such that the process steps related to quality control may then be easily accessed, retrieved, manipulated, displayed, or have other operations performed on them. Based upon the derived measures described above, quantified benchmark scores between similar, but not optimized, processes may be delivered and/or presented to the customer.

The savings may be calculated at the central location and transmitted to the remote customer site for subsequent reproduction and use. Alternatively, the savings may be calculated at the remote customer site. For example, after the customer has downloaded a benchmarked workflow, a processor at the customer site may compare the process steps of the benchmarked workflow or a modified benchmarked workflow with the worksteps of the corresponding workflow as currently implemented by the customer.

The method 100 may include receiving some form of payment 118 from the customer. The payment 118 may involve clinical partners that have developed the processes being compensated by direct payment, sharing revenue generated by the workflows, or receiving the opportunity of promotion through a website employed, such as a portal used to access and search the certified database or to implement the workflows. In connection with the web service, revenues may be “fee per delivered sub-process,” or free to the end-user and financed through sponsors on a web-based tool. In one aspect, the so-called Internet business model may be implemented. The Internet business method may be implemented using the disclosure of U.S. Pat. No. 7,136,875, incorporated herein by reference in its entirety, that describes serving advertisements based on content. Other manners of advertising via the Internet and webpages associated with accessing/searching the certified database or implementing the workflows may be used.

FIG. 2 illustrates another exemplary method of developing and distributing a benchmarked or optimized benchmarked clinical workflow 200. The left hand side of FIG. 2 illustrates steps preferably performed at a central location 202 and the right hand side illustrates steps preferably performed at a customer location 204, such as a remote healthcare institution. The actions associated with the central location may include developing benchmarked workflows 206, receiving customer specific specifications 210, and/or modifying a benchmarked workflow based upon the customer specifications 212 to create a tailored or optimized clinical workflow. The actions performed at the remote customer location may include providing customer specifications 208 and/or remotely receiving a tailored workflow 214. Additional, fewer, or alternate steps may be performed at either the central location or the remote customer site, including, but not limited to, those discussed herein or associated with FIG. 1.

As discussed above, the method may include developing benchmarked workflows 206. After development, the benchmarked workflows 206 may be stored in a certified database in machine readable form. The user may remotely access the certified database via a communications network, such as the Internet.

The customer may provide customer specifications to the central location or a processor at the central location 208 via a user interface located at the customer's site. The customer specifications may include illness type, patient characteristics, symptoms, geographical location, medical resources and equipment, and other medical information.

In one aspect, interactive software applications are used at various customer locations. The software applications may rely upon customer specifications, such as customer protocols, to properly run various pieces of equipment. The customer protocols may account for hardware and hardware configurations, as well as the customer's software configurations. The customer protocols may include all settings and parameters related to the type of computers and/or machines that the software application operates on at the customer location. The customer specific data may include all of the individual customer data and settings used by a software application or medical imaging device.

The customer specifications may be transmitted via customer specific data to a processor at the central location 210. The customer also may provide a form of payment as discussed elsewhere herein at this time 210.

Based upon the customer specific data received, a benchmarked workflow may be automatically or manually modified to account for the customer specific data 212 at the central location. Data associated with the modified benchmarked workflow (tailored process) may then be transmitted to a customer site. After receipt of the data associated with the tailored process 214, a graphical, textual, computer, video, audio, or combination of thereof, and/or other virtual representation of the tailored process may be generated to illustrate the proper performance of the tailored process at the customer location.

Alternatively, the benchmarked and/or modified benchmarked workflows may be transferred to the customer site via a portable storage medium, such as digital versatile disc, compact disc, or other electronic storage unit. Other methods of transferring the virtual representations of workflows to the customer site may be used.

### II. Exemplary Data Processing System

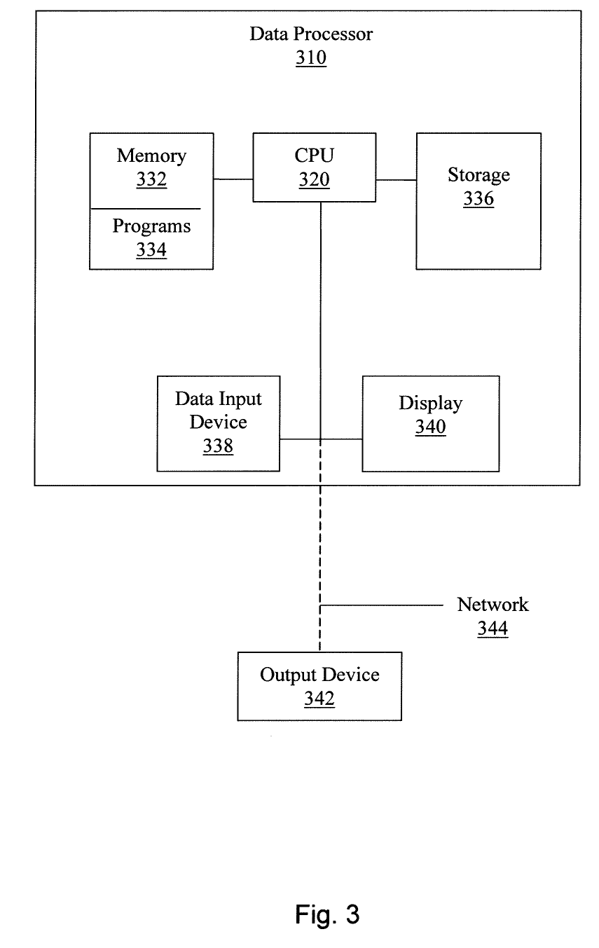

FIG. 3 illustrates an exemplary data processor 310 configured or adapted to provide the functionality for developing and distributing benchmarked or optimized clinical workflows. The data processor 310 may be located at a central location. The data processor may include a central processing unit (CPU) 320, a memory 332, a storage device 336, a data input device 338, and a display 340. The processor 310 also may have an external output device 342, which may be a display, a monitor, a printer or a communications port. The processor 310 may be a personal computer, work station, PACS station, or other medical imaging system. The processor 310 may be interconnected to a network 344, such as an intranet, the Internet, or an intranet connected to the Internet. The processor 310 may be interconnected to a customer system or a remote location via the network 344. The data processor 310 is provided for descriptive purposes and is not intended to limit the scope of the present system. The processor may have additional, fewer, or alternate components.

A program 334 may reside on the memory 332 and include one or more sequences of executable code or coded instructions that are executed by the CPU 320. The program 334 may be loaded into the memory 332 from the storage device 336. The CPU 320 may execute one or more sequences of instructions of the program 334 to process data. Data may be input to the data processor 310 with the data input device 338 and/or received from the network 344 or customer system. The program 334 may interface with the data input device 338 and/or the network 344 or customer system for the input of data. Data processed by the data processor 310 may be provided as an output to the display 340, the external output device 342, the network 344, the customer system, and/or stored in a database.

The program 334 and other data may be stored on or read from a machine-readable medium, including secondary storage devices such as hard disks, floppy disks, CD-ROMS, and DVDs; electromagnetic signals; or other forms of machine readable medium, either currently known or later developed. The program 334, memory 332, storage unit 336, and other data may comprise and store a certified database of machine readable files and data associated with benchmarked clinical processes. The certified database may be organized such that the benchmarked clinical processes and associated data may be searchable and retrievable via a search engine operating over a network, such as the network 344.

In one embodiment, the data processor 310 may be operable to automatically or semi-automatically modify the benchmarked clinical workflow to account for customer specifications and/or restrictions. The modified workflows also may be stored within the certified database or other memory unit. A virtual benchmarked workflow (in digital data or machine readable form) may be received by the data processor 310 from the certified database, data input device 338, the network 344, or another input device. After which, the data processor 310 may revise the workflow to create a virtual modified workflow (in digital data or machine readable form) that may be stored in the memory 332, the storage device 336, or other storage unit.

Customer specific data detailing customer specifications related to the clinical workflows, such as customer resource restrictions, preferences, or characteristics, may be received from a customer location by the data processor 310 via the data input device 338, the network 344, the customer system, or another input device. The data processor 310 may modify a benchmarked clinical workflow using the customer specific data to achieve an estimated optimized workflow based upon analysis of the customer specifications.

In other words, the data processor 310 may integrate the customer specific data with a benchmarked workflow selected by the user to modify the workflow to create an optimized benchmarked clinical workflow tailored to the customers wants and needs. The integration of the customer specific data with a benchmarked version of the workflow by the data processor 310 may be fully or partially automated.

The data processor 310 may compute various savings, such as manhours, time, and money, associated with the implementation of a benchmarked clinical workflow or a modified benchmarked clinical workflow at the customer site. The savings may account for the customer specifications and/or the customers equipment and other resources.

The data processor 310 may accept search terms entered by a customer and transfer data associated with the search terms to the central location via the network 344, the output device 342, or other manner. Based upon the search terms and search logic and/or predetermined rules, one or more clinical workflows may be retrieved from the certified database by the data processor 310. For example, a scrollable list of benchmarked workflows may be retrieved from which the user may select a desired workflow using a mouse, pointer, touch screen, or other input device.

The original and modified benchmarked clinical workflow descriptions may be transferred to customer location via the network 344, output device 342, or other manner. The workflows transferred may be in the form of machine readable graphical and/or textual representations, executable versions of software applications, data to alter software applications installed at the customers locations, stand alone applications, modifications or revisions to pre-existing applications, or other forms.

### III. Exemplary Clinical Workflows and Related Software Applications

In the aspect that the clinical workflows are directed toward the medical field, the customer locations may be hospitals, clinics, or other medical facilities. The customer personnel may include doctors, nurses, and other medical personnel. The clinical workflows and associated software applications may assist the medical personnel with the diagnosis of medical conditions and the treatment of patients.

The clinical workflows and associated software applications may relate to processing images illustrating an enhanced region of interest within a patient. For example, various types of contrast medium may be administered to a medical patient. The contrast mediums enhance the scans acquired by scanning a patient or images of the patient, the scans and images may be recorded by an external recording device as enhancement data. The contrast medium typically travels through a portion of the body, such as in the blood stream, and reaches an area that medical personnel are interested in analyzing. While the contrast medium is traveling through or collected within a region of interest, a series of scans or images of the region of interest of the patient may be recorded for processing and display by the software applications. The enhanced region of interest may show the brain, the abdomen, the heart, the liver, a lung, a breast, the head, a limb or any other body area.

The expected enhancement data may be generated for one or more specific type of image clinical workflows that are used to produce the images or scans of the patient. In general, the types of imaging clinical workflows that may be used to produce patient images or scans of internal regions of interest include radiography, angioplasty, computerized tomography, ultrasound and magnetic resonance imaging (MRI). Additional types of imaging clinical workflows that may be used include perfusion and diffusion weighted MRI, cardiac computed tomography, computerized axial tomographic scan, electron-beam computed tomography, radionuclide imaging, radionuclide angiography, single photon emission computed tomography (SPECT), cardiac positron emission tomography (PET), digital cardiac angiography (DSA), and digital subtraction angiography (DSA). Alternate imaging processes may be used.

In one aspect, each clinical workflow and related software application may have customer protocols or other customer specific data dependent upon the type of imaging process(es) or imaging processing device that the software application supports. The customer protocols may comprise all of the settings for the operating machines and medical imaging modules and subroutines associated with the software application in order to generate medical image data. The settings may be manufacturer, supplier, or distributor specific or may be customized by the customer. For example, the customer protocols may account for the type of machine used by the customer and/or comprise settings for magnetic resonance imaging devices, computer tomography devices, and other imaging devices, including, but not limited to, devices pertaining to the imaging processes mentioned directly above.

Additionally, some institutions may be relatively inexperienced with whole body imaging using medical imaging devices. Whole body imaging procedures may acquire a large amount of images, the vast majority of which may be irrelevant to a region of interest to be analyzed. Benchmarking may help identify the most relevant images and/or images to be analyzed acquired via a whole body imaging workflow so that medical personnel can focus their attention on the most pertinent images acquired. Therefore, benchmarking imaging workflows may reduce inefficiencies associated with whole body imaging workflows.

The customer protocols also may account for the respective image type. For instance, the customer protocols may account for images generated by angiographic, orthopedic, or other imaging processes, including, but not limited to, the imaging processes mentioned directly above. Additionally, the customer protocols may account for the location of the region of interest displayed in the images, such as the cranium, the brain, the abdomen, the heart, the liver, a lung, a breast, the head, a limb, the torso, or any other body area.

The customer specific data may pertain to a customized user interface of the previous version of the software application. For instance, each medical software application may use customer specific data related to displaying customized windows or text boxes that present messages to be displayed and accept directions from a user, such as what information is to be analyzed. The customer specific data also may pertain to displaying one or more customized floating windows to present analyzed data and generate text messages with recommendations and diagnosis. The customer specific data also may relate to customized software tool tips that may enhance the effectiveness and the efficiency of the users utilizing the software. The tool tips may be accessible from a menu or pop-up window that the user accesses via a mouse, keyboard, touchpad, or other input device. The customer specific data may pertain to additional, fewer, or alternate user specific settings and customizations, as well as the equipment, manpower, funding, and other resource restrictions.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A method of distributing a benchmarked clinical workflow, the method comprising:
offering remote access to a certified database containing machine readable representations of a plurality of benchmarked clinical workflows, the certified database being remotely searchable via a communications network.

2. The method of claim 1, wherein the certified database is remotely searchable via a search engine operable to search for and retrieve a machine readable representation of a desired benchmarked clinical workflow from the certified database.

3. The method of claim 1, the method comprising:
selecting a benchmarked clinical workflow from the certified database; and
automatically modifying the selected benchmarked clinical workflow based upon customer specifications using a processor.

4. The method of claim 3, wherein the customer specifications account for resource restrictions of a customer.

5. The method of claim 3, the method comprising providing information regarding the effects associated with the modification of the selected benchmarked clinical workflow upon the benchmarked clinical workflow.

6. The method of claim 1, the method comprising deriving a savings quantification with an implementation of a benchmarked clinical workflow selected from the certified database.

7. The method of claim 1, the method comprising placing advertisements on webpages associated with accessing the certified database via the communications network.

8. The method of claim 1, the method comprising deriving savings for cost, duration, and/or manpower associated with an implementation of a benchmarked clinical workflow by measuring correlated parameters of one or more everyday clinical uses of an installed clinical workflow engine.

9. The method of claim 1, the method comprising deriving process quality measures by measuring the number of warnings, alarms, and/or error messages during one or more everyday clinical uses of an installed clinical workflow engine.

10. The method of claim 1, the method comprising;
deriving benchmark performance parameters that quantify the quality of a workflow; and
visually identifying process steps within the workflow associated with maintaining quality control.

11. A method of distributing a benchmarked clinical workflow, the method comprising:
building a certified database containing virtual representations of benchmarked clinical workflows; and
distributing the virtual representations of the benchmarked clinical workflows over a communications network via a search engine operable to search the certified database for a desired benchmarked clinical workflow.

12. The method of claim 11, the method comprising:
accepting customer specific data via the communications network;
accepting a selection of the desired benchmarked clinical workflow from the certified database via the communications network; and
modifying the desired benchmarked clinical workflow selected to account for the customer specific data.

13. The method of claim 11, the method comprising deriving at least one savings quantification associated with an implementation of a selected benchmarked clinical workflow at a remote customer location.

14. The method of claim 11, the method comprising:
optimizing at least one of the benchmarked clinical workflows based upon customer specification data;
creating a virtual representation of the optimized benchmarked clinical workflow; and
distributing the virtual representation of the optimized benchmarked clinical workflow to a remote location via the communications network.

15. The method of claim 11, wherein the virtual representations stored in the certified database are model descriptions for benchmarked clinical workflows to be implemented in a medical workflow support system.

16. The method of claim 11, the method comprising placing advertisements on one or more webpages associated with the distribution of the virtual representations stored in the certified database.

17. The method of claim 11, the method comprising deriving savings for cost, duration, and/or manpower associated with an implementation of a benchmarked clinical workflow by measuring correlated parameters of one or more everyday clinical uses of an installed clinical workflow engine.

18. The method of claim 11, the method comprising deriving process quality measures by measuring the number of warnings, alarms, and/or error messages during one or more everyday clinical uses of an installed clinical workflow engine.

19. The method of claim 11, the method comprising;
deriving benchmark performance parameters that quantify the quality of a workflow; and
graphically and/or textually presenting the benchmark performance parameters.

20. A data processing system for distributing a benchmarked clinical workflow, the system comprising:
a memory unit located at a central location operable to store a certified database including virtual representations of benchmarked clinical workflows; and
a processing unit located operable to (1) permit remote searching of the certified database for a desired clinical workflow via a search engine over a communications network, and (2) offer remote access via the communications network to a virtual representation of a benchmarked clinical workflow remotely selected from the certified database.

21. The data processing system of claim 20, wherein the processing unit is operable to (3) receive customer specification data related to the benchmarked clinical workflow remotely selected, (4) modify the benchmarked clinical workflow remotely selected to account for the customer specification data, and (5) transmit data associated with the modified benchmarked clinical workflow over the communications network to a remote location.

22. The data processing system of claim 20, wherein the processing unit is operable to post advertisements on a webpage associated with searching the certified database.

23. The data processing system of claim 20, wherein the processor is operable to quantify savings associated with an implementation of a benchmarked clinical workflow when compared to a current implementation of an associated clinical workflow.

24. The data processing system of claim 20, wherein the processor is operable to present a graphical representation associated with a benchmarked clinical workflow that maps process steps of the benchmarked clinical workflow to corresponding clinical guidelines.

25. A computer-readable medium having instructions executable on a computer stored thereon, the instructions comprising:
receiving customer specific data related to a benchmarked clinical workflow from a remote customer location;
modifying the benchmarked clinical workflow based upon the customer specific data; and
transferring a virtual representation of the modified benchmarked clinical workflow to the remote customer location.

26. The computer-readable medium of claim 25, the instructions comprising:
accepting search terms sent from a remote location over a communications network;
using the search terms to search a database containing virtual representations of a plurality of benchmarked clinical workflows; and
retrieving or listing one or more virtual representations of benchmarked clinical workflows based upon the search terms.

27. The computer-readable medium of claim 25, the instructions comprising presenting advertisements on a webpage associated with receiving or implementing a benchmarked clinical workflow.

28. The computer-readable medium of claim 25, the instructions comprising deriving a savings associated with an implementation of a selected benchmarked clinical workflow and presenting the savings on a display.
